(19) United States
(12) Patent Application Publication
(10) Pub. No.: US 2018/0322503 A1
(43) Pub. Date: Nov. 8, 2018

(54) FINGERPRINT SCANNER SECURITY DEVICE

(71) Applicant: INTERNATIONAL BUSINESS MACHINES CORPORATION, Armonk, NY (US)

(72) Inventors: DOMINIC L. DEMARCO, HYDE PARK, NY (US); THOMAS D. FITZSIMMONS, ELVERSON, PA (US); TROY A. FLAGG, HYDE PARK, NY (US); RYAN P. GOLDEN, HYDE PARK, NY (US)

(21) Appl. No.: 15/586,324

(22) Filed: May 4, 2017

(51) Int. Cl. G06Q 20/40; G07F 7/08; G07C 9/00; G06Q 50/26; G06K 9/00

(52) U.S. Cl. CPC G06Q 20/40145; G07F 7/0833; G07C 9/00158; G07F 7/0813; G06K 9/00087; G06Q 20/4093; G06Q 50/265; G06K 9/00013; G06Q 20/4016

(57) ABSTRACT

Methods, systems and computer program products for identifying stolen payment cards using a fingerprint scanner are provided. Aspects include receiving, by a transaction processing terminal, a payment card and scanning, by the fingerprint scanner, a surface of the payment card and capturing fingerprints disposed on the surface of the payment card. Aspects also include comparing, by a processor, the captured fingerprints to one or more authorized fingerprints associated with the payment card. Based on detecting that the captured fingerprints are different than the one or more authorized fingerprints, aspects further include determining whether the payment card has been reported stolen. Based on a determination that the payment card has been reported stolen, aspects include creating and transmitting an alert of an attempted use of the payment card.

### BACKGROUND

The present invention relates generally to systems, methods, and computer program products for obtaining fingerprints from payment cards and, more specifically, to identifying stolen payment cards using a fingerprint scanner.

Theft of payment cards, such as credit cards, debit cards, or gift cards, is a common problem. In some cases, when a thief uses a stolen payment card at commercial locations, a camera system may be able to take a picture of the thief. However, often the camera quality is too poor to capture an identifiable image of the thief or the thief actively conceals their face with face-obscuring clothing, such as sunglasses, a hat or a mask. Accordingly, it can be difficult to determine the identity of a user of a stolen payment card.

### SUMMARY

Embodiments include computer-implemented methods, systems, and computer program products for identifying stolen payment cards using fingerprint scanners. The method includes receiving, by a transaction processing terminal, a payment card and scanning, by the fingerprint scanner, a surface of the payment card and capturing fingerprints disposed on the surface of the payment card. The method also includes comparing, by a processor, the captured fingerprints to one or more authorized fingerprints associated with the payment card. Based on detecting that the captured fingerprints are different than the one or more authorized fingerprints, the method further includes determining whether the payment card has been reported stolen. Based on a determination that the payment card has been reported stolen, the method also includes creating and transmitting an alert of an attempted use of the payment card.

Additional features are realized through the techniques of the present invention. Other embodiments and aspects of the invention are described in detail herein and are considered a part of the claimed invention. For a better understanding of the invention with the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features of embodiments of the invention are apparent from the following detailed description taken in conjunction with the accompanying drawings in which:

FIG. 1 depicts a block diagram of a system for identifying stolen payment cards using a fingerprint scanner in accordance with an embodiment of the present invention;

FIG. 2 depicts a block diagram of a processing system in accordance with an embodiment of the present invention;

FIG. 3 depicts a flow diagram of a method for identifying stolen payment cards using a fingerprint scanner in accordance with an embodiment of the present invention; and

FIG. 4 depicts a flow diagram of a method for identifying stolen payment cards using a fingerprint scanner in accordance with another embodiment of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments include systems, methods and computer program products for identifying stolen payment cards using a fingerprint scanner. In exemplary embodiments, a transaction processing terminal includes a card scanner that is configured to detect and capture fingerprints on the surface of a payment card when the payment card is used at the transaction processing terminal. In one embodiment, the design of the transaction processing terminal requires the payment card to be inserted into a slot for the magnetic stripe or chip on the card to be read. When the payment card is inserted, the card scanner scans the surface of the card and captures any fingerprints disposed on the surface of the card. In exemplary embodiments, the fingerprints are then compared to stored fingerprints associated with authorized users of the payment card. Based on a determination that the captured fingerprints do not match those of authorized users, the transaction processing system can take a corrective action.

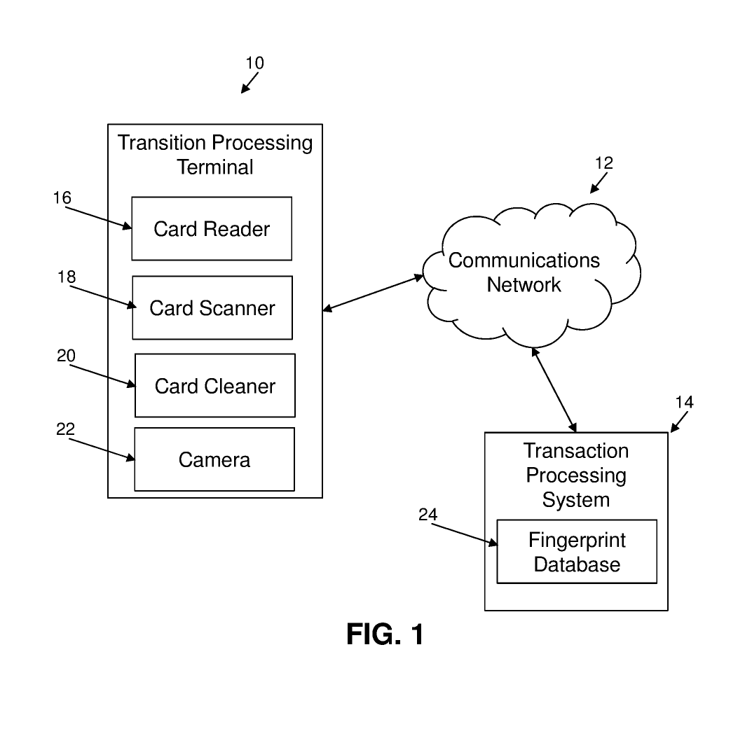

Referring now to FIG. 1, a block diagram of a system for identifying stolen payment cards using a fingerprint scanner in accordance with an embodiment of the present invention is shown. As shown, the system includes a transaction processing terminal 10 that is in communication with a transaction processing system 14 via a communications network 12. The transaction processing terminal 10 can be an Automated Teller Machine (ATM), a point of sale (POS) terminal, or the like. The transaction processing terminal 10 includes a card reader 16 that is configured to read the magnetic strip of the payment card or the chip of the payment card to retrieve account information. The transaction processing terminal 10 includes a card scanner 18 that is configured to scan the surface of the payment card for fingerprints and to capture images of any fingerprints disposed on the payment card. In exemplary embodiments, the transaction processing terminal 10 also includes and a card cleaner 20 that is configured to clean the surface of the payment card after the card scanner 18 obtains the fingerprint data from the surface of the payment card. In exemplary embodiments, the card cleaner 20 is configured to clean the surface of the payment card such that new fingerprints deposited on the surface of the payment card can be more easily identified if re-inserted into the transaction processing terminal 10. In exemplary embodiments, the transaction processing terminal 10 also includes a camera 22 that can be used to capture an image of the user of a payment card.

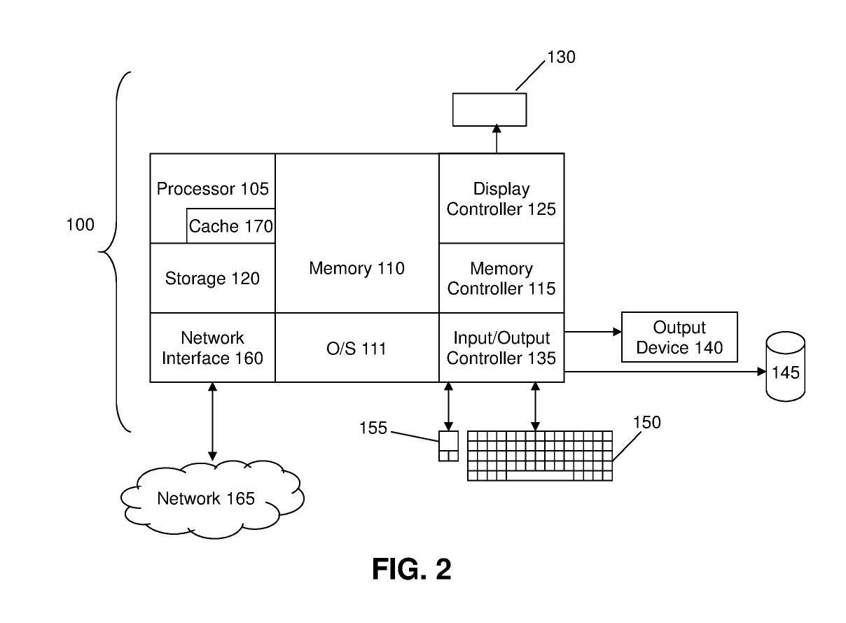

In exemplary embodiments, the transaction processing system 14 includes a fingerprint database 24 that is used to store fingerprints that are associated with one or more authorized users of a payment card. In addition, the fingerprint database 24 can be used to store fingerprints captured from transaction processing terminals 10. In exemplary embodiments, the transaction processing system 14 may be embodied in a processing system such as the one shown in FIG. 2.

FIG. 2 illustrates a block diagram of a processing system 100 for use in implementing a system or method according to some embodiments. The systems and methods described herein may be implemented in hardware, software (e.g., firmware), or a combination thereof. In some embodiments, the methods described may be implemented, at least in part, in hardware and may be part of the microprocessor of a special or general-purpose computer, such as a personal computer, workstation, minicomputer, or mainframe computer.

In some embodiments, as shown in FIG. 2, the processing system 100 includes a processor 105, a memory 110 coupled to a memory controller 115, and one or more input devices 145 and/or output devices 140, such as peripheral or control devices that are communicatively coupled via a local I/O controller 135. These devices 140 and 145 may include, for example, battery sensors, position sensors, cameras, microphones and the like. Input devices such as a conventional keyboard 150 and mouse 155 may be coupled to the I/O controller. The I/O controller 135 may be, for example, one or more buses or other wired or wireless connections, as are known in the art. The I/O controller 135 may have additional elements, which are omitted for simplicity, such as controllers, buffers (caches), drivers, repeaters, and receivers, to enable communications.

The I/O devices 140, 145 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 105 is a hardware device for executing hardware instructions or software, particularly those stored in memory 110. The processor 105 may be a custom made or commercially available processor, a central processing unit (CPU), an auxiliary processor, a semiconductor based microprocessor (in the form of a microchip or chip set), a macroprocessor, or other device for executing instructions. The processor 105 includes a cache 170 that can be organized as a hierarchy of more cache levels (L1, L2, etc.).

The memory 110 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read-only memory (PROM), tape, compact disc read only memory (CD-ROM), disk, diskette, cartridge, cassette or the like, etc.). Moreover, the memory 110 may incorporate electronic, magnetic, optical, or other types of storage media. Note that the memory 110 may have a distributed architecture, where various components are situated remote from one another but may be accessed by the processor 105.

The instructions in memory 110 may include one or more separate programs, each of which comprises an ordered listing of executable instructions for implementing logical functions. In the example of FIG. 2, the instructions in the memory 110 include a suitable operating system (OS) 111. The operating system 111 essentially may control the execution of other computer programs and provides scheduling, input-output control, file and data management, memory management, and communication control and related services.

Additional data, including, for example, instructions for the processor 105 or other retrievable information, may be stored in storage 120, which may be a storage device such as a hard disk drive or solid state drive. The stored instructions in memory 110 or in storage 120 may include those enabling the processor to execute one or more aspects of the systems and methods of this disclosure.

The processing system 100 may further include a display controller 125 coupled to a user interface or display 130. In some embodiments, the display 130 may be an LCD screen. In some embodiments, the processing system 100 may further include a network interface 160 for coupling to a communications network 165. The network 165 may be an IP-based network for communication between the processing system 100 and an external server, client and the like via a broadband connection. In some embodiments, the network 165 may be a managed IP network administered by a service provider. The communications network 165 may be implemented in a wireless fashion, e.g., using wireless protocols and technologies, such as WiFi, WiMax, satellite, etc. The communications network 165 may also be a packet-switched network such as a local area network, wide area network, metropolitan area network, the Internet, or other similar type of network environment. The communications network 165 may be a fixed wireless network, a wireless local area network (LAN), a wireless wide area network (WAN) a personal area network (PAN), a virtual private network (VPN), intranet or other suitable network system and may include equipment for receiving and transmitting signals.

Systems and methods according to this disclosure may be embodied, in whole or in part, in computer program products or in the processing system 100, such as that illustrated in FIG. 2.

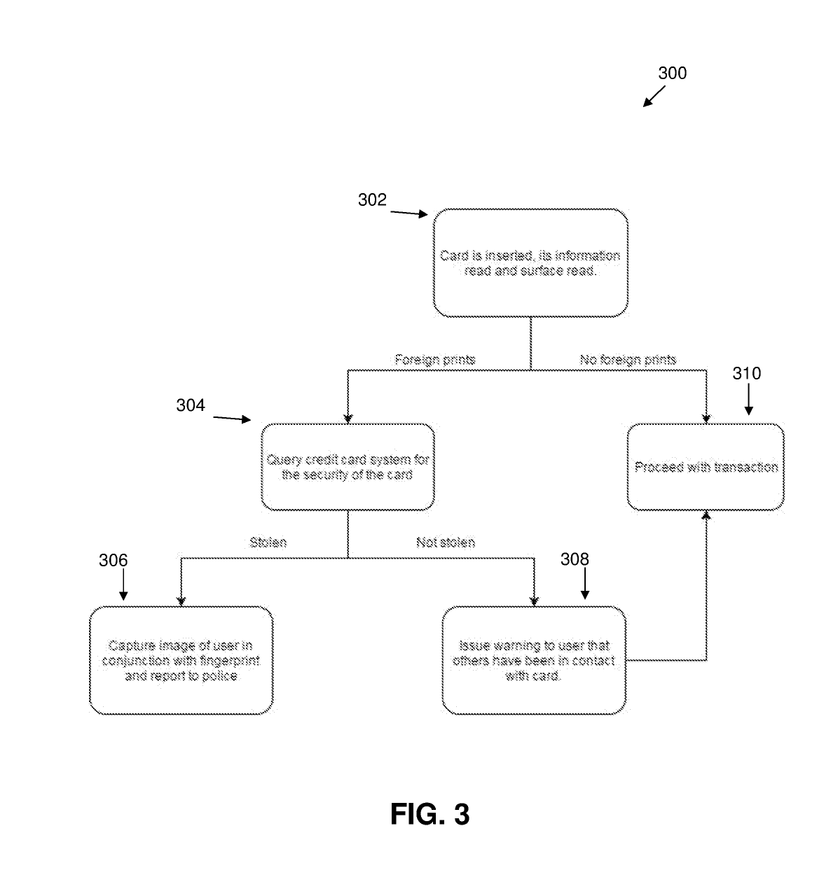

Referring now to FIG. 3 a flow diagram of a method 300 for identifying stolen payment cards using a fingerprint scanner in accordance with an embodiment of the present invention is shown. The method 300 includes receiving a card by a transaction processing terminal, reading information stored on the payment card, and obtaining fingerprints from the surface of the payment card, as shown at block 302. If the fingerprints obtained from the surface of the payment card include foreign prints, or prints not associated with an authorized user of the payment card, the method 300 proceeds to block 304. If the fingerprints obtained from the surface of the payment card do not include foreign prints, the method 300 proceeds to block 310. As shown at block 304, the method includes querying a transaction processing system, or credit card system, to determine if the payment card has been reported stolen. If the payment card has been reported stolen, the method proceeds to block 306. Otherwise, the method 300 proceeds to block 308.

As shown at block 306, the method 300 includes capturing an image of the user of the payment card and transmitting an alert regarding the use of the stolen payment card to the police. In exemplary embodiments, the alert can also include any captured fingerprint data from the surface of the payment card, the location of the transaction processing terminal at which the payment card was used and the captured image of the user of the payment card. In one embodiment, the transaction processing terminal can be configured to alert an employee at the location of the transaction processing terminal payment card is stolen. In another embodiment, the transaction processing terminal can be configured to retain the stolen card, i.e., not return the stolen card to the user. In a further embodiment, the transaction processing terminal is configured to deny the requested transaction.

As shown at block 308, the method 300 includes issuing a warning to an owner of the payment card that other individuals have been in contact with the payment card. The warning can be an email, text, or phone call to the owner of the payment card that notifies the owner of the foreign fingerprints detected on their payment card. In exemplary embodiments, the owner can control how, and if, they desire to receive such warnings and under what conditions they desire to receive such warnings. For example, a user may only request to receive such a warning when the payment card is used a new location and in which unidentified fingerprints are detected. The method 300 also includes authorizing the requested transaction, as shown at block 310.

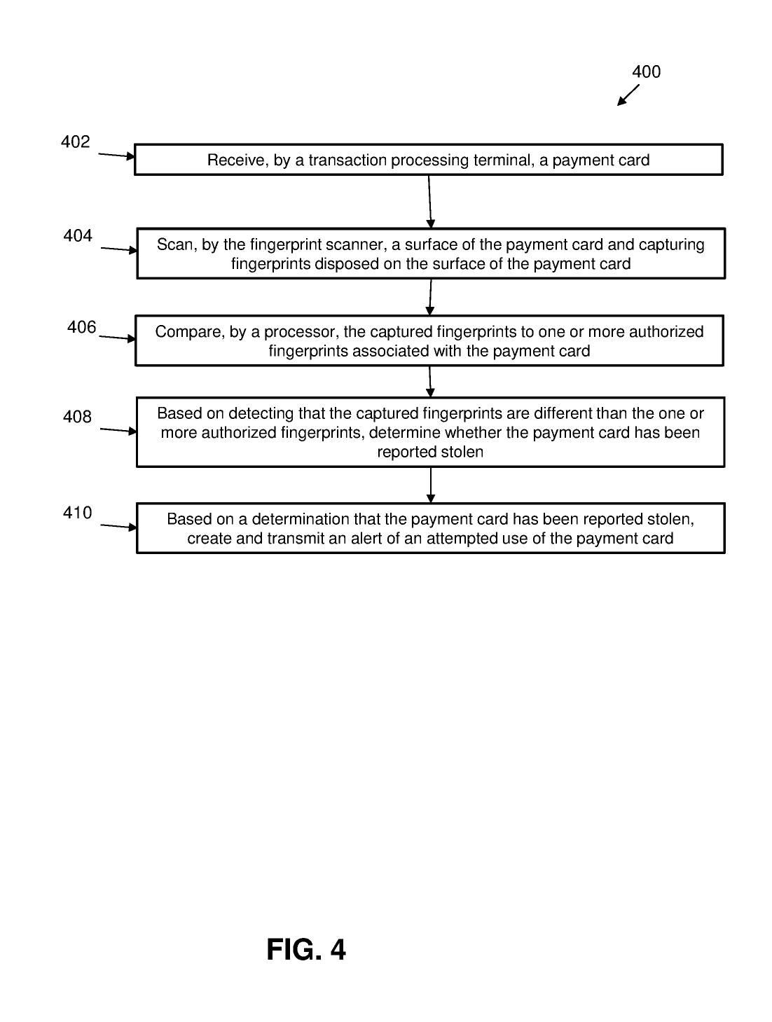

Referring now to FIG. 4 a flow diagram of a method 400 for identifying stolen payment cards using a fingerprint scanner in accordance with another embodiment of the present invention is shown. The method 400 includes receiving, by a transaction processing terminal, a payment card, as shown at block 402. Next, as shown at block 404, the method 400 includes scanning, by a fingerprint scanner of the transaction processing terminal, a surface of the payment card and capturing fingerprints disposed on the surface of the payment card. The method 400 also includes comparing the captured fingerprints to one or more authorized fingerprints associated with the payment card, as shown at block 406. In one embodiment, the transaction processing terminal can receive the authorized fingerprints from the transaction processing system and perform the comparison of the fingerprints. In another embodiment, the transaction processing terminal can transmit the captured fingerprints to the transaction processing system, which can perform the comparison of the captured fingerprints to the stored authorized fingerprints.

Continuing with reference to FIG. 4, the method 400 also includes determining whether the payment card has been reported stolen based on a detection that the captured fingerprints are different than the one or more authorized fingerprints, as shown at block 408. Next, as shown at block 410, the method 400 includes creating and transmitting an alert of an attempted use of the payment card based on a determination that the payment card has been reported stolen. In exemplary embodiments, an image of a user of the payment card is captured by a camera of the transaction processing terminal based on a determination that the payment card has been reported stolen. The alert can include an image of the user captured by the camera and a location of the transaction processing terminal. The alert can be transmitted to a law enforcement organization that is determined based on the location of the transaction processing terminal.

In exemplary embodiments, the method 400 can also include creating and transmitting a suspicious activity report to an owner of the payment card based on a determination that the payment card has not been reported stolen. In exemplary embodiments, the suspicious activity report can include an indication of a date, time and location at which the payment card was used where the foreign fingerprints were detected. The suspicious activity report can be generated by the transaction processing system and can be provided to the user in accordance with one or more preferences of the user that are stored in a user profile.

In exemplary embodiments, the transaction processing system can be configured to store one or more authorized fingerprints that are associated with each payment card in a database. In addition, the transaction processing system can store one or more unauthorized fingerprints that are collected from various transaction processing terminals along with an indication of the location at which the unauthorized fingerprints were collected. In some cases, these unauthorized fingerprints can be identified as likely belonging to an employee at the location at which the transaction processing terminal is disposed. For example, the fingerprints of a server at a restaurant with routinely takes an individual card and swipes it a transaction processing terminal at the restaurant may have their fingerprints stored by the transaction processing system as being associated with the transaction processing terminal at the restaurant. In such cases, the detection of the servers fingerprints may not trigger the creation of a suspicious activity report.

In exemplary embodiments, the method 400 can also include cleaning the surface of the payment card prior to dispensing the payment card from the transaction processing terminal. Cleaning of the payment card prior to returning it to the user can allow for a more distinct set of prints if the thief decides to try and use the stolen card elsewhere.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. (canceled)

2. (canceled)

3. (Canceled)

4. (canceled)

5. (canceled)

6. (canceled)

7. (canceled)

8. A system for identifying stolen payment cards using a fingerprint scanner, the system comprising:
a memory;
a transaction processing terminal having a card reader and a card scanner that are communicatively coupled to a processor and the memory, wherein the processor is configured to:
receive, by a transaction processing terminal, a payment card;
scan, by the fingerprint scanner, a surface of the payment card and capturing fingerprints disposed on the surface of the payment card;
compare the captured fingerprints to one or more authorized fingerprints associated with the payment card;
based on detecting that the captured fingerprints are different than the one or more authorized fingerprints, determine whether the payment card has been reported stolen; and
based on a determination that the payment card has been reported stolen, create and transmit an alert of an attempted use of the payment card.

9. The system of claim 8, wherein an image of a user of the payment card is captured by a camera of the transaction processing terminal based on a determination that the payment card has been reported stolen.

10. The system of claim 9, wherein the alert includes the image of the user captured by the camera and a location of the transaction processing terminal.

11. The system of claim 10, wherein the alert is transmitted to a law enforcement organization that is determined based on the location of the transaction processing terminal.

12. The system of claim 8, wherein the processor is further configured to create and transmit a suspicious activity report to an owner of the payment card based on a determination that the payment card has not been reported stolen.

13. The system of claim 8, wherein the transaction processing terminal further comprising a card cleaner configured to clean the surface of the payment card prior to dispensing the payment card from the transaction processing terminal.

14. The system of claim 8, wherein the processor is further configured to proceed with authorization of a requested transaction based on a determination that the captured fingerprints are among the one or more authorized fingerprints.

15. A computer program product comprising a computer readable storage medium having program instructions embodied therewith, the program instructions executable by a processor to cause the processor to perform a method comprising:
receiving, by a transaction processing terminal, a payment card;
scanning, by a fingerprint scanner, a surface of the payment card and capturing fingerprints disposed on the surface of the payment card;
comparing the captured fingerprints to one or more authorized fingerprints associated with the payment card;
based on detecting that the captured fingerprints are different than the one or more authorized fingerprints, determining whether the payment card has been reported stolen; and
based on a determination that the payment card has been reported stolen, creating and transmitting an alert of an attempted use of the payment card.

16. The computer program product of claim 15, wherein an image of a user of the payment card is captured by a camera of the transaction processing terminal based on a determination that the payment card has been reported stolen.

17. The computer program product of claim 16, wherein the alert includes the image of the user captured by the camera and a location of the transaction processing terminal.

18. The computer program product of claim 17, wherein the alert is transmitted to a law enforcement organization that is determined based on the location of the transaction processing terminal.

19. The computer program product of claim 15, the method further comprising creating and transmitting a suspicious activity report to an owner of the payment card based on a determination that the payment card has not been reported stolen.

20. The computer program product of claim 15, further comprising cleaning the surface of the payment card prior to dispensing the payment card from the transaction processing terminal.
